(19) United States
(12) Patent Application Publication
(10) Pub. No.: US 2014/0136097 A1
(43) Pub. Date: May 15, 2014

(54) ANTI-COLLISION SYSTEM OF VEHICLE

(71) Applicant: DENSO CORPORATION, Kariya-city (JP)

(72) Inventor: Norio Tsuchida, Kariya-shi (JP)

(73) Assignee: DENSO CORPORATION, Kariya-city (JP)

(21) Appl. No.: 14/078,950

(22) Filed: Nov. 13, 2013

(30) Foreign Application Priority Data
Nov. 14, 2012 (JP) 2012-250010

(51) Int. Cl. B60W 30/09

(52) U.S. Cl. CPC B60W 30/09
USPC 701/301

(57) ABSTRACT

An anti-collision system for preventing collision of a vehicle has an object detector that detects a periphery object of the vehicle; a prevention actuation portion that performs actuation for preventing the collision of the vehicle with the periphery object detected by the object detector; and an actuation timing change portion configured to change an actuation timing of the prevention actuation portion, the actuation timing being a timing of actuation of the prevention actuation portion depending on the detection of the periphery object by the object detector, the actuation timing change portion delaying the actuation timing more steeply than when accelerating the actuation timing.

### CROSS-REFERENCE TO RELATED APPLICATION

This application is based on and claims the benefit of priority from earlier Japanese Patent Application No. 2012-250010 filed Nov. 14, 2012, the description of which is incorporated herein by reference.

### BACKGROUND OF THE INVENTION

1. Technical Field of the Invention

The present invention relates to a system for preventing collision of a vehicle with a peripheral object.

2. Related Art

An example of such a system is disclosed in the patent document (Japanese Patent Publication No 2006-215862). In this system, an alarm device is actuated at an actuation timing (for example, the alarm device is actuated at 100 m before an obstacle) which is sometimes changed, and the system limits the change rate of the actuation timing such that the change degree (for example, from 100 m to 60 m) of the actuation timing is not excessively large. According to the description in the patent document, driver confusion or discomfort about the change in actuation timing of the alarm device can be prevented.

### SUMMARY

However, when the actuation timing is changed, especially when the changed actuation timing is faster than a proper value, for example, on the basis of false recognition of an obstacle, the alarm device is actuated unnecessarily.

It is thus desired to provide an anti-collision system that can prevent a driver from such discomfort, and prevent unnecessary actuation.

An exemplary embodiment provides an anti-collision system for preventing collision of a vehicle. The anti-collision system has an object detector that detects a peripheral object of the vehicle; a prevention actuation portion that performs actuation for preventing the collision of the vehicle with the periphery object detected by the object detector; and an actuation timing change portion configured to change an actuation timing of the prevention actuation portion, the actuation timing being a timing of actuation of the prevention actuation portion depending on the detection of the periphery object by the object detector, the actuation timing change portion delaying the actuation timing more steeply than when accelerating the actuation timing.

### BRIEF DESCRIPTION OF THE DRAWINGS

In the accompanying drawings:

FIG. 1 is a block diagram showing configurations of an anti-collision system;

FIG. 2 is a flow chart showing process flow of an actuation timing change control according to a first embodiment;

FIG. 3 is a timing chart showing an example of the change of the actuation timing;

FIG. 4 is a timing chart showing another example of the change of the actuation timing;

FIG. 5 is a timing chart showing an example of a modified actuation timing change control;

FIG. 6 is a flow chart showing process flow of an actuation timing change control according to a second embodiment;

FIG. 7 is a timing chart showing an example of the change of the actuation timing.

### DETAILED DESCRIPTION OF THE PREFERRED EMBODIMENTS

### First Embodiment

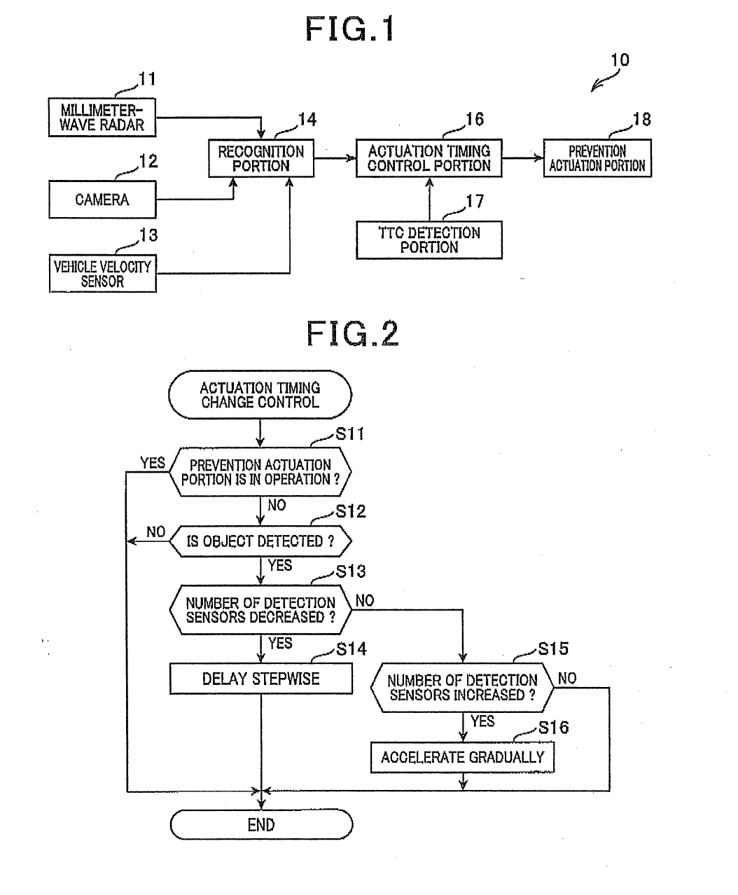

Hereinafter, a first embodiment is described, referring to the drawings. This embodiment is embodied as an anti-collision system which is mounted on a vehicle and prevents collision of the vehicle with a periphery object. As shown in FIG. 1, the anti-collision system 10 has a millimeter-wave radar 11, a camera 12, a vehicle velocity sensor 13, a recognition portion 14, an actuation timing control portion 16, a TTC detection portion 17, and a prevention actuation portion 18.

The millimeter-wave radar (object detector) 11 is provided at the anterior portion of the vehicle. The millimeter-wave radar 11 detects objects in a predetermined range in front of the vehicle with millimeter band radio waves. In detail, the millimeter-wave radar 11 detects a distance from the vehicle to an object, and relative velocity between the vehicle and the object. The camera (object detector) 12 is a stereo camera or a monocular camera, and images the periphery of the vehicle to obtain images. The vehicle velocity sensor 13 detects velocity of the vehicle.

The recognition portion 14, the actuation timing control portion 16, and the TTC detection portion 17 are composed of an ECU (Electronic Control Unit). The ECU is a known microcomputer having a CPU, a ROM, a RAM, storage, and input-output interfaces etc.

The recognition portion 14 obtains the distance from the vehicle to an object, and the relative velocity between the vehicle and the object, which are detected in the millimeter-wave radar 11. Then, the recognition portion 14 recognizes any object whose distance from the vehicle is shorter than a predetermined distance as an obstacle. The recognition portion 14 obtains the vehicle velocity detected in the vehicle velocity sensor 13, and calculates the velocity of the object on the basis of the relative velocity and the vehicle velocity. Then, the recognition portion 14 recognizes the objects whose velocity is larger than a predetermined velocity as a moving object, and recognizes the objects whose velocity is smaller than a predetermined velocity as a stationary object.

The recognition portion 14 obtains an image from the camera 12. Then, the recognition portion 14 compares the obtained image with a reference pattern to recognize periphery objects which are positioned within a predetermined area from the own vehicle as obstacles, and recognizes types of the obstacles, for example, another vehicle, a pedestrian, a guardrail or a street tree. Then, the recognition portion 14 (object detector) recognizes motional state of the obstacle, i.e., recognizes another vehicle and a pedestrian etc. as a moving object, and recognizes a guardrail and a street tree etc. as a stationary object. The pedestrian may be recognized as the stationary object.

The TTC detection portion 17 detects time-to-collision TTC at a predetermined period. Time-to-collision is allowances until the collision of the vehicle. In this embodiment, the TTC detection portion 17 calculates time-to-collision TTC which is allowances until the collision with the detected obstacle, on the basis of the detection results of the sensors such as the millimeter-wave radar 11, the camera 12 and the vehicle velocity sensor 13. The known method can be used for the detection of the time-to-collision TTC.

The actuation timing control portion (actuating timing change portion) 16 determines timing for actuating the prevention actuation portion 18, on the basis of the recognition results of the recognition portion 14. Specifically, the actuation timing control portion 16 determines the actuation timing by determining time-to-collision TTC when actuating the prevention actuation portion 18, as a determination value TE. That is to say, in this embodiment, the actuation timing is timing or timing threshold for starting the actuation of the prevention actuation portion 18, and the actuation timing control portion 16 determines how long before the collision of the vehicle it actuates the prevention actuation portion 18.

The actuation timing control portion 16 compares the determination value TE with the time-to-collision TTC detected by the TTC detection portion 17. Then, the actuation timing control portion 16 actuates the prevention actuation portion 18, when it has determined the time-to-collision TTC has become shorter than the determination value TE. For example, the actuation timing control portion 16 actuates the braking system at x seconds before the collision, x being smaller than the determination value.

The prevention actuation portion 18 actuates to prevent the vehicle from colliding with periphery objects, on the basis of the detection results of the sensors such as the millimeter-wave radar 11 and the camera 12. Specifically, the prevention actuation portion 18 is an alarm device, a braking system of the vehicle, and so on. The prevention actuation portion 18 is actuated at the actuation timing determined by the actuation timing control portion 16. In detail, the prevention actuation portion 18 is actuated when the time-to-collision TTC becomes shorter than the determination value TE. Other devices such as a seat-belt pretensioner which tightens a seatbelt at a seat of the vehicle may be actuated with the actuation of the prevention actuation portion 18.

Here, the actuation timing control portion 16 changes the actuation timing of the prevention actuation portion 18, when detection states detected by the millimeter-wave radar 11 and the camera 12 have changed.

Next, process flow of the actuation timing change control is described, referring to FIG. 2. This flow is repeated at a predetermined period by the actuation timing control portion 16.

At first, the actuation timing control portion 16 determines whether the prevention actuation portion 18 is in operation (S11). Specifically, the actuation timing control portion 16 determines whether the time-to-collision TTC becomes shorter than the determination value TE. The actuation timing control portion 16 may obtain an actuation state of the prevention actuation portion 18, and may determine whether the prevention actuation portion 18 is in operation on the basis of the obtained actuation state.

In the above-described determination, if the actuation timing control portion 16 determines the prevention actuation portion 18 is in operation (S11: YES), it terminates the flow until the next iteration (END). That is to say, changing the actuation timing is prohibited, while the prevention actuation portion 18 is in operation.

On the other hand, if the actuation timing control portion 16 determines the prevention actuation portion 18 is not in operation (S11: NO), it determines whether the millimeter-wave radar 11 or the camera 12 detects an object which is an obstacle of the vehicle (S12). In detail, the actuation timing control portion 16 determines whether the object detected by the millimeter-wave radar 11 or the camera 12 (sensor) is recognized as an obstacle on the basis of the recognition results in the recognition portion 14.

In the above-described determination, if the actuation timing control portion 16 determines the millimeter-wave radar 11 or the camera 12 has not detected an object which is the obstacle of the vehicle (S12: NO), it terminates the flow until the next iteration (END). On the other hand, if the actuation timing control portion 16 determines the millimeter-wave radar 11 or the camera 12 detects an object which is the obstacle of the vehicle (S12: YES), it determines whether the number of the sensors which are detecting the object being the obstacle of the vehicle has decreased (S13).

In the above-described determination, if the actuation timing control portion 16 determines the number of the sensors which are detecting the object being the obstacle of the vehicle has decreased (S13: YES), it stepwise delays the actuation timing of the prevention actuation portion (S14). Specifically, if the determination value TE is a determination value TE2 before the change, the actuation timing control portion 16 changes the determination value to a determination value TE1 which is shorter than the determination value TE2 immediately (in one step).

On the other hand, if the actuation timing control portion 16 determines the number of the sensors which are detecting the object being the obstacle of the vehicle has not decreased (S13: NO), it determines whether the number of the sensors which are detecting the object being the obstacle of the vehicle has increased (S15).

In the above-described determination, if the actuation timing control portion 16 determines the number of the sensors which are detecting the object being the obstacle of the vehicle has not increased (S15: NO), it terminates the flow until the next iteration. That is to say, if the number of the sensors which are detecting the object being the obstacle of the vehicle has not changed, the actuation timing of the prevention actuation portion 18 is not changed.

On the other hand, if the actuation timing control portion 16 determines the number of the sensors which are detecting the object being the obstacle of the vehicle has increased (S15: YES), it gradually accelerates (advances) the actuation timing of the prevention actuation portion 18 (S16). In detail, the actuation timing control portion 16 gradually accelerates the actuation timing of the prevention actuation portion 18 at a constant change rate (time rate of change) by gradually lengthening the determination value TE from a determination value TE1 to a determination value TE2 at a constant rate. Then, the actuation timing control portion 16 terminates the flow until the next iteration (END).

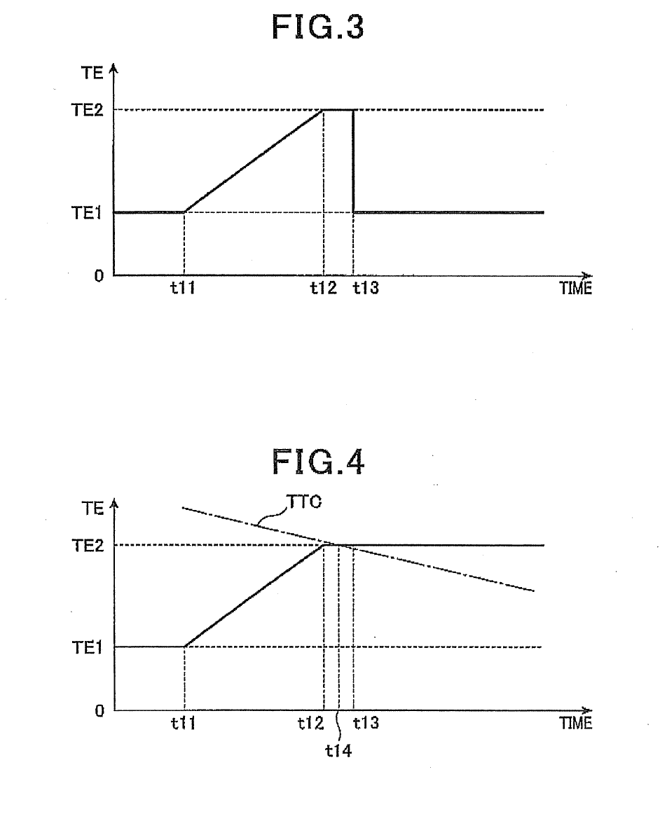

Next, an example of changing actuation timing according to the actuation timing change control shown in FIG. 2 is described, referring to FIG. 3.

When a plurality of sensors which detect periphery objects of the vehicle are provided, the larger the number of the sensors which have detected the object being the obstacle of the vehicle is, the higher the reliability of the detection becomes. Therefore, for inhibiting unnecessary actuation of the prevention actuation portion 18, it is desirable that the larger the number of the sensors which have detected the object being the obstacle of the vehicle is, the faster the actuation timing of the prevention actuation portion 18 is changed to be. Similarly, it is desirable that the smaller the number of the sensors which have detected the object being the obstacle of the vehicle is, the later the actuation timing of the prevention actuation portion 18 is changed to be.

In FIG. 3, before time t11, the object which is an obstacle of the vehicle is detected by the millimeter-wave radar 11 or the camera 12, and the determination value TE is set to a determination value TE1. That is to say, when reliability of the detection of the obstacle is low, the determination value TE is set short, i.e., the timing of the prevention actuation portion 18 is set late. When the object which is an obstacle of the vehicle is not detected by the millimeter-wave radar 11 or the camera 12, the determination value TE is set to zero, and the prevention actuation portion 18 is not actuated.

At time t11, the object which is an obstacle of the vehicle is detected by both of the millimeter-wave radar 11 and the camera 12. Then, the determination value TE is gradually lengthened, which gradually accelerates the actuation timing of the prevention actuation portion 18. That is to say, when the reliability of the detection of the obstacle increases, the determination value TE is gradually lengthened, i.e., the actuation timing of the prevention actuation portion 18 is gradually accelerated. Therefore, sudden actuation of the prevention actuation portion 18 is prevented.

At time t12, the determination value TE is lengthened to a determination value TE2 when the object which is an obstacle of the vehicle is detected by the millimeter-wave radar 11 and the camera 12, and is subsequently kept at the determination value TE2.

At time t13, the millimeter-wave radar 11 and the camera 12 enter a state in which either the millimeter-wave radar 11 or the camera 12 does not detect the object being the obstacle of the vehicle, i.e., a state in which the millimeter-wave radar 11 or the camera 12 detects the object being the obstacle of the vehicle. At this time, the determination value TE is changed from the determination value TE2 to the determination value TE1 in one step, which stepwise delays the actuation timing of the prevention actuation portion 18. That is to say, when the reliability of the detection of the obstacle decreases, the determination value TE is steeply shortened, i.e., the actuation timing of the prevention actuation portion 18 is steeply delayed. If the actuation timing of the prevention actuation portion 18 is delayed, the prevention actuation portion 18 cannot actuate suddenly.

Next, an example of changing actuation timing when the prevention actuation portion 18 actuates, referring to FIG. 4.

As shown in FIG. 4, until time t12, just like FIG. 3, the determination value TE is gradually changed from the determination value TE1 to the determination value TE2. Then, the determination value TE is kept at the determination value TE2 after time t12. At time 14, the time-to collision TTC becomes shorter than the determination value TE2, then the prevention actuation portion 18 is actuated.

Here, if the actuation timing of the prevention actuation portion 18 is delayed during the actuation of the prevention actuation portion 18, the actuating prevention actuation portion 18 might stop suddenly. For this, even when either the millimeter-wave radar 11 or the camera 12 becomes in the state in which it does not detect the object being the obstacle of the vehicle, delaying the actuation timing during the actuation of the prevention actuation portion 18 is inhibited. Therefore, the prevention actuation portion 18 is kept actuating.

The above-described embodiment has following advantages.

When the actuation timing control portion 16 delays the actuation timing of the prevention actuation portion 18, it changes the actuation timing more steeply than when it accelerates the actuation timing. Therefore, the actuation timing of the prevention actuation portion 18 is delayed more steeply, compared to when the actuation timing of the prevention actuation portion 18 is accelerated. This prevents unnecessary actuation of the prevention actuation portion 18 quickly.

Compared to when delaying the actuation timing of the prevention actuation portion 18, when the actuation timing control portion 16 accelerates the actuation timing of the prevention actuation portion 18, it changes the actuation timing gradually. Therefore, the sudden actuation of the prevention actuation portion 18 due to accelerating the actuation timing of the prevention actuation portion 18 can be prevented. When the actuation timing control portion 16 delays the actuation timing of the prevention actuation portion 18, even if it steeply changes the actuation timing, the prevention actuation portion 18 cannot suddenly actuate. Therefore, a driver is prevented from an uncomfortable feeling.

When the detection state of the periphery objects by a plurality of sensors changes, causing a driver an uncomfortable feeling can be prevented, and unnecessary actuation of the prevention actuation portion 18 can be prevented.

When the number of the sensors which are detecting the periphery object as an obstacle decreases, the actuation timing of the prevention actuation portion 18 is delayed. Therefore, when the reliability of the detection of the periphery object is reduced, the actuation timing control portion 16 delays the actuation timing of the prevention actuation portion 18, which can prevent unnecessary actuation of the prevention actuation portion 18.

When the actuation timing is delayed, it is stepwise changed. Therefore, unnecessary actuation of the prevention actuation portion 18 is prevented immediately.

When the actuation timing is accelerated, it is gradually changed. Therefore, the prevention actuation portion 18 is prevented from suddenly actuating. As a result, causing a driver an uncomfortable feeling can be prevented.

The actuating prevention actuation portion 18 can be prevented from suddenly stopping, because delaying the actuation timing during the actuation of the prevention actuation portion 18 is inhibited. As a result, causing a driver an uncomfortable feeling can be prevented.

The above-described embodiment may be modified as follows.

As shown in FIG. 5, when accelerating the actuation timing (i.e., lengthening the determination value TE), the actuation timing control portion 16 may accelerate at a rate which changes with time, in place of accelerating at the constant rate.

When delaying the actuation timing (shortening the determination time TE), the actuation timing control portion 16 may stepwise delay not at one step but at a small number of steps (for example, two steps). Specifically, when the anti-collision system 10 has other sensors such as a sensor which receives signals from transmitters provided on a road for signaling presence of an obstacle, the actuation timing control portion 16 may change the actuation timing of the prevention actuation portion 18 in a small number of steps, depending on the number of the sensors which are detecting a periphery object as an obstacle. For example, when the number of the sensors which are detecting the periphery object as the obstacle is three (time t12 to t15), the determination value TE is set to a determination value TE2, then, when the number is two (time t15 to t16), the determination value TE is set to a determination value TE3, and then, when the number is one (after time t16), the determination value TE is set to a determination value TE1.

Even in this case, when the actuation timing of the prevention actuation portion 18 is delayed (time t15, t16), it is changed more steeply than when it is accelerated. For this, the actuation timing of the prevention actuation portion 18 is delayed more steeply than when it is accelerated, unnecessary actuation of the prevention actuation portion 18 can be prevented quickly.

### Second Embodiment

Hereinafter, a second embodiment according to the present invention is described, referring to the drawings. In the first embodiment, when the number of the sensors which are detecting the object as the obstacle of the vehicle is changed, the actuation timing control portion 16 changes the actuation timing of the prevention actuation portion 18. In this embodiment, when the recognition result of the object which is detected as the obstacle of the vehicle changes between the moving object and the stationary object, the actuation timing control portion 16 changes the actuation timing of the prevention actuation portion 18. Other points are the same as the first embodiment. Therefore, the same reference symbols are used for the same portions and processes as the first embodiment, and descriptions are omitted.

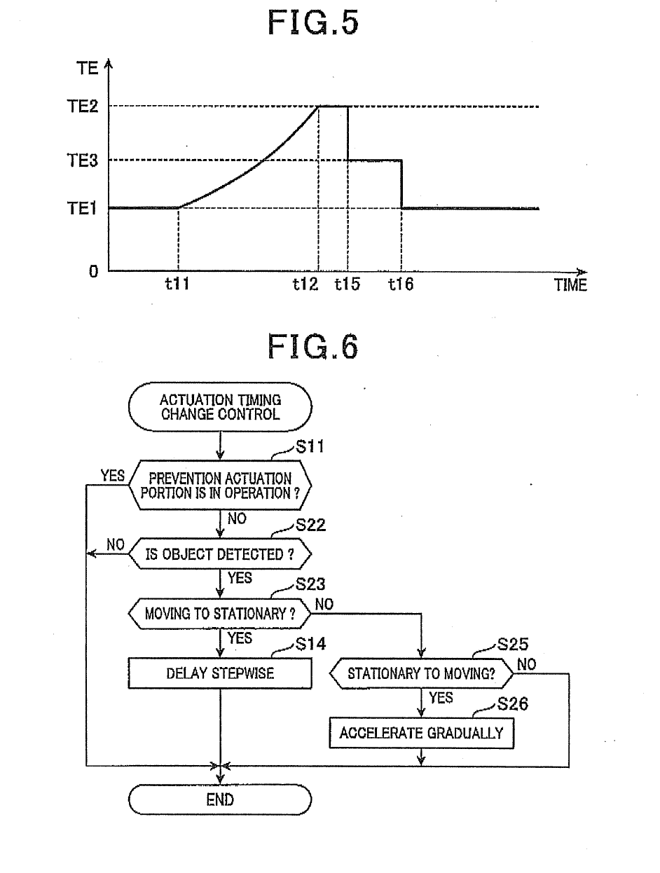

As shown in FIG. 6, at step S22, when the actuation timing control portion 16 determines at least one of the millimeter-wave radar 11 and camera 12 detects the object as the obstacle of the vehicle (YES), it determines whether or not the recognition result of the object which is detected as the obstacle of the vehicle has changed from being a moving object to a stationary object (S23). Specifically, when the recognition result according to the camera 12 changes from the moving object to the stationary object, the actuation timing control portion 16 determines that the recognition result of the object has changed from a moving object to a stationary object.

In the above-described determination, when the recognition result of the object which is detected as the obstacle of the vehicle changes from the moving object to the stationary object (S23: YES), the actuation timing control portion 16 stepwise delays the actuation timing of the prevention actuation portion 18 (S14).

On the other hand, the actuation timing control portion 16 determines that the recognition result of the object which is detected as the obstacle of the vehicle does not change from the moving object to the stationary object (S23; NO), it determines whether the recognition result of the object which is detected as the obstacle of the vehicle has changed from a stationary object to a moving object (S25). Specifically, when the recognition result at least according to the camera 12 changes from a stationary object to a moving object, the actuation timing control portion 16 determines that the recognition result of the object has changed from a stationary object to a moving object.

In the above-described determination, when the actuation timing control portion 16 determines that the recognition result of the object has not changed from stationary object to moving object (S25: NO), the flow is terminated until the next iteration (END). That is to say, the recognition result of the object which is detected as the obstacle of the vehicle does not change, the actuation timing control portion 16 does not change the actuation timing of the prevention actuation portion 18.

On the other hand, in the above-described determination, when the actuation timing control portion 16 determines that the recognition result of the object has changed from the stationary object to the moving object (S25: YES), it gradually accelerates the actuation timing of the prevention actuation portion 18 (S26). In detail, the actuation timing control portion 16 gradually accelerates the actuation timing of the prevention actuation portion 18 at multiple steps. Then, the flow is terminated until the next iteration (END).

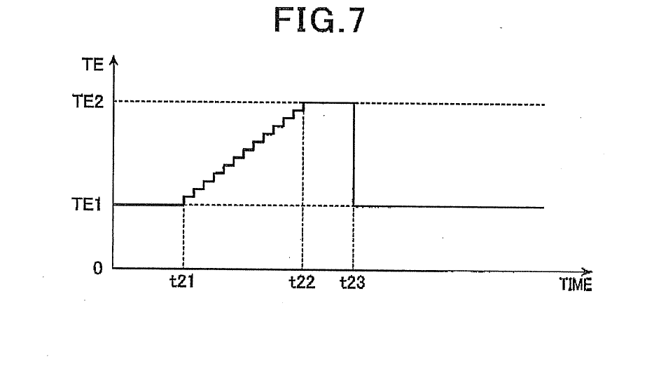

Next, an example of the change of the actuation timing according to the actuation timing change control shown in FIG. 6, referring to FIG. 7.

When the object which the sensor is detecting as the obstacle of the vehicle is a moving object, the reliability of the detection is higher than when the object is stationary object. Therefore, for inhibiting unnecessary actuation of the prevention actuation portion 18, it is desirable that the actuation timing of the prevention actuation portion 18 is accelerated, when the recognition result of the object which the sensor is detecting as the obstacle is a moving object, and that the actuation timing of the prevention actuation portion 18 is delayed, when the recognition result is a stationary object.

As shown in FIG. 7, before time t21, the recognition result at least according to the camera 12 is a stationary object, and the determination value TE is set to a determination value TE1. That is to say, when the reliability of the detection of the object as the obstacle is low, the determination value TE is set short, and the actuation timing of the prevention actuation portion 18 is set late.

At time t21, when the recognition result at least according to the camera 12 changes from the stationary object to the moving object, the determination value TE is gradually lengthened. This gradually accelerates the actuation timing of the prevention actuation portion 18. That is to say, when the reliability of the detection of the object as the obstacle is increased, the determination value TE is gradually lengthened at multiple steps, i.e., the actuation timing of the prevention actuation portion 18 is gradually accelerated at multiple steps. Therefore, sudden actuation of the prevention actuation portion 18 can be prevented.

At time t22, the determination value TE is lengthened to the determination value TE2 when the recognition result of the object at least according to the camera 12 is the moving object. After that, the determination value TE is kept at the determination value TE2.

At time t23, the recognition result of the object at least according to the camera 12 changes from the moving object to the stationary object. At this time, the determination value TE is changed from the determination value TE2 to the determination value TE1 at one step, for this, the actuation timing of the prevention actuation portion 18 is stepwise delayed. That is to say, when the reliability of the detection of the object as the obstacle is decreased, the determination value TE is steeply shortened, i.e., the actuation timing of the prevention actuation portion 18 is steeply delayed.

The second embodiment detailed above has following advantages. Only different advantages from the first embodiment are described below.

When the recognition result of a periphery object which the sensor is detecting as an obstacle changes from a moving object to a stationary object, the actuation timing of the prevention actuation portion 18 is delayed. Therefore, when the reliability of the detection of the periphery object is decreased, unnecessary actuation of the prevention actuation portion 18 can be prevented by delaying the actuation timing of the prevention actuation portion 18.

When the recognition result by the sensor changes from a stationary object to a moving object, the actuation timing of the prevention actuation portion 18 is gradually accelerated. Therefore, when the reliability of the periphery object is increased, sudden actuation of the prevention actuation portion 18 can be prevented by gradually accelerating the actuation timing of the prevention actuation portion 18.

The above-describe second embodiment can be modified as follows.

When the recognition results according to both of the millimeter-wave radar 11 and the camera 12 change between a moving object and a stationary object, the actuation timing of the prevention actuation portion 18 may be changed. Alternatively, the anti-collision system may use only one of the millimeter-wave radar 11 and the camera 12 for the determination, and may be configured to change the actuation timing of the prevention actuation portion 18 in the case where the recognition result according to the used sensor changes between a moving object and a stationary object.

### Other Embodiment

The above-describe embodiments can be modified as follows.

Only one of the alarming system and the braking system which compose the prevention actuation portion 18 may be actuated. That is to say, the anti-collision system only has to actuate at least one of devices composing the prevention actuation portion 18.

The actuation timing is not limited to time-to-collision TTC when the prevention actuation portion is changed in operation, it may be distance to the obstacle etc. That is to say, the actuation timing only has to include information which can identify actuation timing rather than being the actuation timing itself.

In the above-described embodiments, when the detection states by the sensors changes, the actuation timing of the prevention actuation portion 18 is changed. Alternatively, the actuation timing of the prevention actuation portion 18 may be changed on the basis of other triggers, for example, on the basis of detection of the driver's operation of the vehicle. Even in this case, when delaying the actuation timing of the prevention actuation portion 18, the anti-collision system only has to delay more steeply than when accelerating the timing. As a result, sudden actuation of the prevention actuation portion 18 can be inhibited quickly, and unnecessary actuation of the prevention actuation portion can be prevented.

Though the invention has been described with respect to the specific preferred embodiments, many variations and modifications will become apparent to those skilled. In the art upon reading the present application. It is therefore the intention that the claims be interpreted as broadly as possible in view of the prior art to include all such variations and modifications.

1. An anti-collision system for preventing collision of a vehicle, comprising:
an object detector that detects a periphery object of the vehicle;
a prevention actuation portion that performs actuation for preventing the collision of the vehicle with the periphery object detected by the object detector; and
an actuation timing change portion configured to change an actuation timing of the prevention actuation portion, the actuation timing being a timing of actuation of the prevention actuation portion depending on the detection of the periphery object by the object detector, the actuation timing change portion delaying the actuation timing more steeply than when accelerating the actuation timing.

2. The anti-collision system according to claim 1, wherein, the actuation timing change portion is configured to change the actuation timing depending on change in the detection status of the periphery object by the object detector.

3. The anti-collision system according to claim 2, wherein:
a plurality of object detectors are provided; and
the actuation timing change portion is configured to change the actuation timing depending on change in number of the object detector.

4. The anti-collision system according to claim 2, wherein:
the objection detector configured to detect motional state of the detected periphery object, the motional state being either moving or stationary;
the actuation timing change portion is configured to change the actuation timing depending on the detected motional state.

5. The anti-collision system according to claim 1, wherein,
the actuation timing change portion is configured to change the actuation timing, when delaying the actuation timing.

6. The anti-collision system according to claim 1, wherein,
the actuation timing change portion is configured to stepwise change the actuation timing gradually, when accelerating the actuation timing.

7. The anti-collision system according to claim 1, wherein,
the actuation timing change portion is configured to inhibit to delay the actuation timing when the prevention actuation portion is in operation.
